(19) United States
(12) Patent Application Publication
(10) Pub. No.: US 2007/0146481 A1
(43) Pub. Date: Jun. 28, 2007

(54) Rear view mirror for a motor vehicle

(75) Inventors: Pao Chen, Milpitas, CA (US); Ian Bennett, Portola Valley, CA (US); Daniel Rosario, Santa Cruz, CA (US); Arne Stoschek, Palo Alto, CA (US)

Correspondence Address: LERNER GREENBERG STEMER LLP, P O BOX 2480, HOLLYWOOD, FL, 33022-2480, US

(73) Assignee: VOLKSWAGEN AG

(21) Appl. No.: 11/299,508

(22) Filed: Dec. 12, 2005

(51) Int. Cl. H04N 7/18

(52) U.S. Cl. 348/148

(57) ABSTRACT

A rearview mirror for a motor vehicle, in particular for a convertible, has a display that displays information by emitting light. A reflective-type linear polarization layer is disposed in front of the display layer, with reference to a defined viewing direction. There is no absorption-type polarization layer disposed in front of the reflective-type linear polarization layer, with reference to a defined viewing direction.

### BACKGROUND OF THE INVENTION

### Field of the Invention

The invention lies in the field of automotive technology. More specifically, the invention relates to a rearview mirror for a motor vehicle.

U.S. Pat. No. 6,106,121 discloses a rearview mirror for a motor vehicle. The mirror comprises an LCD display and two polarizing layers that are transparent in an unpowered state.

A mirror with a display is marketed by Philips (Koninklijke Philips Electronics N.V., Netherlands) under the designation MirrorTV.

European patent EP 0 719 675 B1 discloses an inside mirror of a vehicle with a display apparatus, the display apparatus comprising a mirror body, a rearview mirror, provided in a front opening of the mirror body, for reflecting an image behind a vehicle back to a driver's point of view, and an information display mirror, provided in the mirror body, for reflecting the visual information displayed by a light emission display device back to the driver's point of view through the information display area, the rearview mirror having a semitransparent reflection film, applied to the entire rear surface of a glass substrate, and a black coated film applied to the rear surface of the semitransparent reflection film, a part of the black coated film being removed for the purpose of forming the information display, and slits provided on the light emission display device being provided for the purpose of guiding the information displayed by the light emission display device in the direction of the information display mirror.

European patent EP 0 635 395 B1 discloses an information device in a motor vehicle, which comprises an electronic circuit that can be connected to an onboard electrical system of the motor vehicle, and one or more sensors, a display apparatus and, if appropriate, operating elements, the sensor and the circuit being accommodated in the housing of a motor vehicle inside mirror, the circuit being connected to a cable that is routed through a hollow support arm of the inside mirror and can be connected to the onboard electrical system, and the display apparatus being integrated in the reflecting glass of the inside mirror.

German patent DE 197 41 896 C2 discloses an apparatus for pictorial display of regions of the surroundings of a motor vehicle in a driver's visual range located in the interior of the motor vehicle, the apparatus comprising at least one display screen on which pictorial information acquired by sensor and processed electronically is displayed, at least one camera being provided with a sensor for acquiring the pictorial information and information relating to the spatial position of the elements of the surroundings of the motor vehicle, a control unit being provided for the electronic processing of the sensor-acquired image information, the control unit being fed operating characteristics of the motor vehicle as input variables, and the control unit switching over between different types of the pictorial display as a function of the operating characteristics.

Further mirrors are disclosed in the following U.S. patents and published patent applications: U.S. Pat. No. 6,646,697 (incorporated by reference); U.S. Pat. Nos. 5,864,432; 6,700,692; 6,648,477; 6,646,806; US 2003/0222982, US 2004/0032675, US 2004/0114384, US 2004/0032676, US 2003/0095047, US 2003/0043480, US 2002/0070872, US 2001/0055143 and US 2001/0013825.

Provisional patent application U.S. 60/622,249 and the corresponding PCT/EP2005/009333 describe a rearview mirror for a motor vehicle, the rearview mirror comprising a reflector layer for reflecting light that strikes the rearview mirror starting from a viewing direction, a display layer, arranged downstream of the reflector layer with reference to the viewing direction, for emitting light, a quarter waveplate arranged between the display layer and the reflector layer, and a reflective-type linear polarization layer arranged between the display layer and the quarter waveplate.

### SUMMARY OF THE INVENTION

It is accordingly an object of the invention to provide a rearview mirror, which overcomes the above-mentioned disadvantages of the heretofore-known devices and methods of this general type and which, in particular, provides for a mirror function and a display function. It is also an object of the invention to provide an improved automobile with a mirror that has a combined mirror/display function.

With the foregoing and other objects in view there is provided, in accordance with the invention, a rearview mirror for a motor vehicle, the rearview mirror comprising:

a display layer for displaying information by emitting light; and

a reflective-type linear polarization layer disposed in front of said display layer with reference to a defined viewing direction, wherein no absorption-type polarization layer is disposed in front of said reflective-type linear polarization layer with reference to the defined viewing direction.

In other words, the above-mentioned and other objects are achieved by way of a rearview mirror for a motor vehicle, in particular for a convertible, the rearview mirror comprising a display layer for displaying information by the emission of light, and a reflective-type linear polarization layer arranged upstream of the display layer with reference to a defined viewing direction, and there being no absorption-type polarization layer, in particular no absorption-type linear polarization layer in front of (upstream of the reflective-type linear polarization layer with reference to a defined viewing direction.

In accordance with an added feature of the invention, the reflective-type linear polarization layer is a passive layer.

The display layer may be formed by comprises an OLED (organic light-emitting diodes) layer or an LCD (liquid crystal display) layer in a further refinement.

At least 40%, particularly at least 45%, of the light that can be emitted counter to the viewing direction by means of the display layer exits from the rearview mirror counter to the viewing direction in a further refinement of the invention.

In accordance with an additional feature of the invention, the rearview mirror comprises a glass layer arranged upstream of the reflective-type linear polarization layer with reference to a defined viewing direction in a further refinement of the invention. In this case, the reflective-type linear polarization layer is permanently connected, in particular bonded to the glass layer in a further refinement of the invention.

Light that can be emitted by way of the display layer is substantially polarized in a direction for which the reflective-type linear polarization layer is transparent in a further refinement of the invention.

The abovementioned object is, additionally, achieved by means of a motor vehicle with a rearview mirror, the rearview mirror comprising a display layer for displaying information by emission of light, and a reflective-type polarization layer arranged upstream of a display layer with reference to a defined viewing direction, and there being no absorption-type polarization layer, in particular no absorption-type linear polarization layer, arranged upstream of the reflective-type polarization layer with reference to a defined viewing direction.

The rearview mirror comprises a glass layer arranged upstream of the reflective-type polarization layer with reference to a defined viewing direction in a further refinement of the invention. In this case, the reflective-type polarization layer is permanently connected, in particular bonded to the glass layer in a further refinement of the invention.

Light that can be emitted by means of the display layer is substantially polarized in a direction for which the reflective-type polarization layer is transparent in a further refinement of the invention.

The reflective-type polarization layer is a reflective-type linear polarization layer in a further refinement of the invention.

The motor vehicle comprises a camera for recording an image of the surroundings of the motor vehicle, in particular a reversing camera, in a further refinement of the invention.

The motor vehicle comprises a display controller for driving the display layer in such a way that the image of the surroundings of the motor vehicle can be displayed by means of the display layer, in a further refinement of the invention.

The abovementioned object is, additionally, achieved by means of a motor vehicle with a rearview mirror, the rearview mirror comprising a display layer for displaying information by emission of light, and a reflective-type polarization layer arranged upstream of a display layer with reference to a defined viewing direction, no mirror layer being arranged upstream of the reflective-type polarization layer with reference to the defined viewing direction.

The abovementioned object is, additionally, achieved by means of a motor vehicle with a rearview mirror, the rearview mirror comprising a display layer for displaying information by emission of light, and a reflective-type polarization layer arranged upstream of a display layer with reference to a defined viewing direction, the reflective-type polarization layer being provided as a mirror layer for producing a mirror image with reference to the defined viewing direction.

The above named object is achieved in addition by means of a convertible with a rearview mirror, the rearview mirror comprising a display layer for displaying information by emission of light; and a reflective-type polarization layer arranged upstream of the display layer with reference to a defined viewing direction.

The convertible comprises a camera for recording an image of the surroundings of the convertible, in particular a reversing camera, in a further refinement of the invention.

The convertible comprises a display controller for driving the display layer in such a way that the image of the surroundings of the convertible can be displayed by means of the display layer, in a further refinement of the invention.

A reflective-type linear polarization layer or a reflective-type polarization layer within the meaning of the invention is transparent to light that is polarized in a first direction, and reflects light that is polarized in a second direction, in particular orthogonal to the first direction. A reflective-type linear polarization layer can be designed, for example, as a so-called DBEF filter layer (DBEF=Dual Brightness Enhancement Films). Details relating to a DBEF filter layer may be found, for example, in the following United States patent literature: U.S. Pat. No. 6,747,618 (incorporated by reference), U.S. Pat. No. 6,753,999 (incorporated by reference), U.S. Pat. No. 6,481,851 (incorporated by reference), and U.S. Pat. No. 6,407,408 (incorporated by reference). A suitable DBEF filter layer can be obtained, for example, from 3M under the designation Vikuiti DBEF.

An absorption-type linear polarization layer or an absorption-type polarization layer is transparent to light that is polarized in a first direction, and absorbs light that is polarized in a second direction, in particular orthogonal to the first direction.

An OLED layer can be designed as a polymer layer or, in particular, a small molecule layer.

A motor vehicle within the meaning of the invention is, in particular, a land vehicle that can be used individually in road traffic. In particular, motor vehicles within the meaning of the invention are not restricted to motor vehicles with an internal combustion engine.

Further advantages and details emerge from the following description of exemplary embodiments.

other features which are considered as characteristic for the invention are set forth in the appended claims.

Although the invention is illustrated and described herein as embodied in a rearview mirror, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view illustrating an exemplary embodiment of the invention in the form of a convertible;

FIG. 2 shows an exemplary embodiment of a rearview mirror with a data connection to a camera;

FIG. 3 shows an exemplary embodiment of a display in a rearview mirror;

FIG. 4 shows a further exemplary embodiment of a display in a rearview mirror;

FIG. 5 shows a further exemplary embodiment of a display in a rearview mirror;

FIG. 6 shows a further exemplary embodiment of a display in a rearview mirror;

FIG. 7 shows a further exemplary embodiment of a display in a rearview mirror;

FIG. 8 shows a further exemplary embodiment of a display in a rearview mirror; and

FIG. 9 shows a schematic illustration of a cross section through a rearview mirror in accordance with FIG. 3.

### DESCRIPTION OF PREFERRED EMBODIMENTS

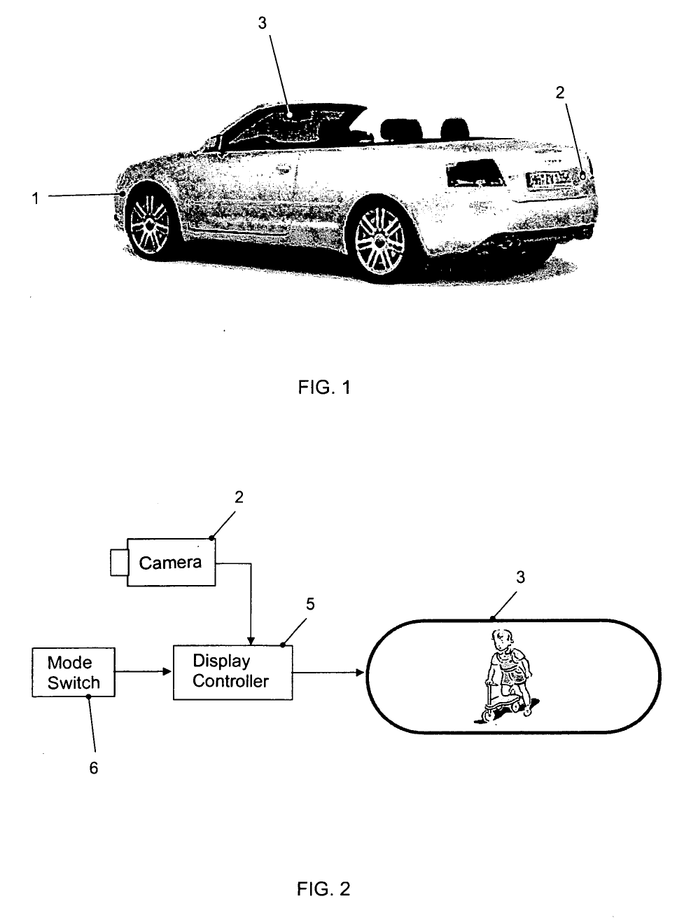

Referring now to the figures of the drawing in detail and first, particularly, to FIG. 1 thereof, there is shown a convertible 1. The convertible 1 is equipped with a camera 2 that has a data connection to a rearview mirror 3 by way of a display controller 5 illustrated in FIG. 2, and is intended for recording an image of the surroundings of the convertible 1. In the exemplary embodiment illustrated, the camera 2 is arranged in this case at the rear end of the convertible 1 such that a region behind the convertible 1, and thus, for example, a child behind the convertible 1—as illustrated in FIG. 2—can be recorded by means of the camera 2 and, through appropriate driving by the display controller 5, can be displayed by means of the rearview mirror 3. That is, the rearview mirror 3 comprises a display function which will be explained with reference to the following Fig.

The rearview mirror 3 fulfills a double function. The rearview mirror 3 can, firstly, be used as a rearview mirror in the conventional sense and, secondly, as a display, it being possible to change between the function as rearview mirror in the conventional sense and the function as display in an optional fashion or in a way coupled to specific operating states of the convertible 1. Thus, for example, it can be provided that the rearview mirror 3 show an image recorded by the camera 2 whenever a reverse gear is selected in the convertible 1, and that the rearview mirror 3 is a rearview mirror in the conventional sense when a forward gear is selected in the convertible 1. It is also possible alternatively or in addition to provide operating means such as, for example, the switch denoted by the reference numeral 6, or a speech input for optionally switching over between the two above named states of the rearview mirror 3.

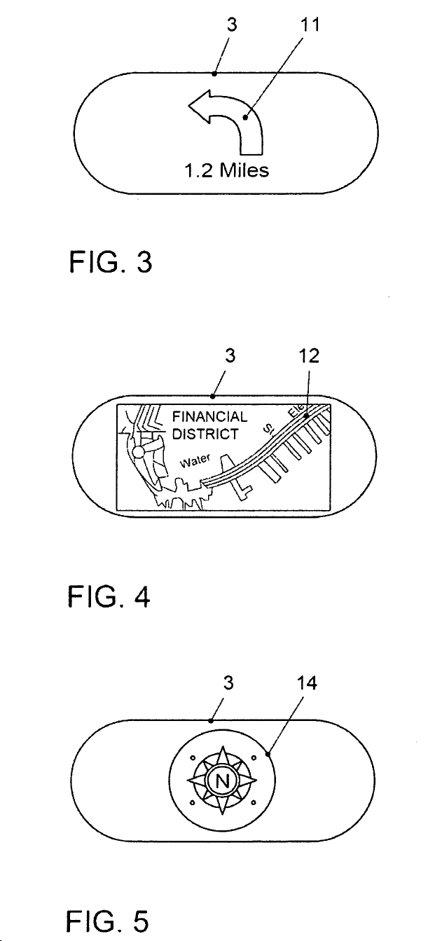

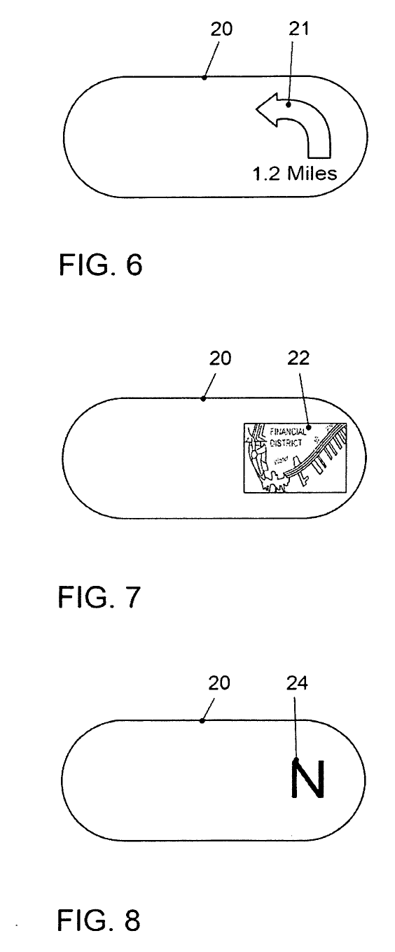

Alternatively, or in addition to the illustration—shown in FIG. 2—of an image recorded by the camera 2, it is also possible for other images to be displayed by means of the rearview mirror 3—as shown in FIG. 3, FIG. 4, FIG. 5, FIG. 6, FIG. 7 and FIG. 8. Thus, FIG. 3 shows an exemplary embodiment of a display of an item of direction information 11, produced by a navigation system, in the rearview mirror 3. FIG. 4 shows an exemplary embodiment of a display of a road map 12, produced by a navigation system, in the rearview mirror 3, and FIG. 5 shows an exemplary embodiment of an item of geographical direction information 14, produced by a compass, in the rearview mirror 3.

As may be seen in FIG. 2 and FIG. 4—it is possible by means of the rearview mirror 3 for the display to extend over a substantial part of the rearview mirror 3. However, it is also possible to provide that only a part of a rearview mirror may be used as display, while another part of such a rearview mirror can also be used as a mirror even in the display state. Such a rearview mirror 20 is shown in FIG. 6, FIG. 7 and FIG. 8, FIG. 6 showing an exemplary embodiment of the display of an item of direction information 21, produced by a navigation system, in the rearview mirror 20, FIG. 7 showing an exemplary embodiment of the display of a road map 22 produced by a navigation system, in the rearview mirror 20 and FIG. 8 showing an exemplary embodiment of the display of an item of geographical direction information 24, produced by a compass, in the rearview mirror 20. In the case of the rearview mirror 20, only the right-hand third of the rearview mirror 20 can be used as display, while the left-hand two thirds of the rearview mirror 20 can also be used as mirror in a display state.

Alternatively or in addition, it is also possible to display further information relating to the convertible 1 such as the distance from an obstacle, the speed of the convertible 1 etc., or the time of day, by means of the rearview mirror 3 or the rearview mirror 20.

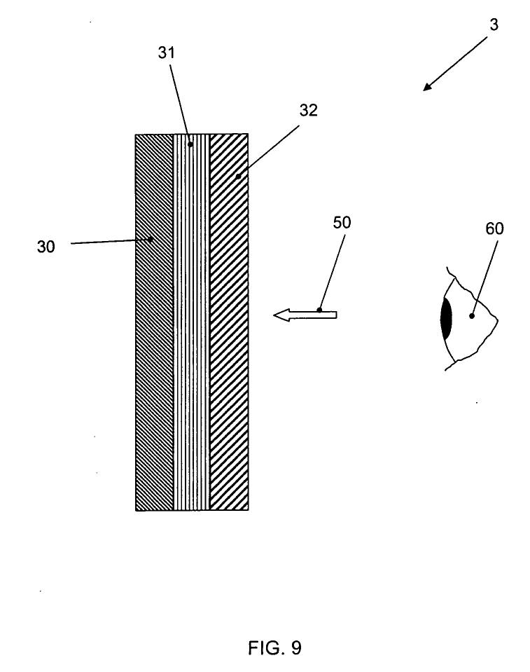

FIG. 9 shows a cross section through the rearview mirror 3 in a schematic illustration. The rearview mirror 3 comprises a reflective-type linear polarization layer 31. The reflective-type linear polarization layer 31 is transparent to light that is polarized in a first direction, and reflects light that is polarized in a second direction, orthogonal to the first direction. The rearview mirror 3 also comprises a display layer 30 that is arranged downstream of (i.e., opposite from) the reflective-type linear polarization layer 31 with reference to a defined viewing direction 50 and is intended for displaying information, for example the information displayed in FIG. 2, FIG. 3, FIG. 4, FIG. 5, FIG. 6, FIG. 7 and FIG. 8, by emission of light. The display layer 30 comprises an OLED (organic LED) layer or an LCD (liquid crystal display) layer. In particular, the display layer 30 is configured in such a way that light emitted by it is substantially polarized in a direction for which the reflective-type linear polarization layer 31 is transparent.

The rearview mirror 3 also comprises a glass layer 32 that is arranged upstream of the reflective-type linear polarization layer 31 with reference to the defined viewing direction 50, and to which the reflective-type linear polarization layer 31 is bonded. Neither an absorption-type polarization layer nor a mirror layer is provided upstream of the reflective-type linear polarization layer 31 with reference to the defined viewing direction 50. The rearview mirror 3 permits a particularly bright and clear display of information by means of the display layer 30 such that this information can be effectively discerned by a viewer 60 even with the folding top of the convertible open.

The elements and layers in the figures are portrayed taking account of simplicity and clarity, and not necessarily to scale. Thus, for example, the orders of magnitude of some elements and/or layers are illustrated in a fashion greatly exaggerated by comparison with other elements and/or layers, in order to improve comprehension of the exemplary embodiments of the present invention.

We claim:

1. A rearview mirror for a motor vehicle, the rearview mirror comprising:
a display layer for displaying information by emitting light; and
a reflective-type linear polarization layer disposed in front of said display layer with reference to a defined viewing direction, wherein no absorption-type polarization layer is disposed in front of said reflective-type linear polarization layer with reference to the defined viewing direction.

2. The rearview mirror according to claim 1, wherein said reflective-type linear polarization layer is a passive layer.

3. The rearview mirror according to claim 1, wherein said display layer is an organic light-emitting diode (OLED) layer.

4. The rearview mirror according to claim 1, wherein said display layer is a liquid crystal display (LCD) layer.

5. The rearview mirror according to claim 1, wherein at least 40% of light that can be emitted counter to the viewing direction by way of said display layer exits from the rearview mirror counter to the viewing direction.

6. The rearview mirror according to claim 1, wherein at least 45% of light that can be emitted counter to the viewing direction by way of said display layer exits from the rearview mirror counter to the viewing direction.

7. The rearview mirror according to claim 1, further comprising a glass layer disposed upstream of said reflective-type linear polarization layer with reference to the defined viewing direction.

8. The rearview mirror according to claim 7, wherein said reflective-type linear polarization layer is permanently connected to said glass layer.

9. The rearview mirror according to claim 7, wherein said reflective-type linear polarization layer is bonded to said glass layer.

10. The rearview mirror according to claim 1, wherein light that can be emitted by way of said display layer is substantially polarized in a direction for which said reflective-type linear polarization layer is transparent.

11. The rearview mirror according to claim 1 configured for integration in a convertible automobile.

12. In a motor vehicle with a rearview mirror, the improvement which comprises, the rearview mirror including:
a display layer for displaying information by emission of light; and
a reflective-type polarization layer disposed in front of said display layer with reference to a defined viewing direction, and wherein no absorption-type polarization layer is disposed in front of said reflective-type polarization layer with reference to the defined viewing direction.

13. The improved motor vehicle according to claim 12, wherein said reflective-type polarization layer is a linear polarization layer.

14. The improved motor vehicle according to claim 12, wherein said display layer is configured to emit light substantially polarized in a direction for which said reflective-type linear polarization layer is transparent.

15. The improved motor vehicle according to claim 12, which further comprises a reversing camera.

16. The improved motor vehicle according to claim 12, which further comprises a camera disposed to recording an image of a surroundings of the motor vehicle.

17. The improved motor vehicle according to claim 16, which further comprises a display controller connected to said camera and to said display layer, for driving said display layer to display the image of the surroundings of the motor vehicle.

18. In a motor vehicle with a rearview mirror, the improvement which comprises, the rearview mirror including:
a display layer for displaying information by emission of light; and
a reflective-type polarization layer disposed in front of said display layer with reference to a defined viewing direction, and no mirror layer disposed in front of said reflective-type polarization layer with reference to the defined viewing direction.

19. In a motor vehicle with a rearview mirror, the improvement which comprises, the rearview mirror including:
a display layer for displaying information by emission of light; and
a reflective-type polarization layer disposed in front of said display layer with reference to a defined viewing direction, said reflective-type polarization layer forming a mirror layer for producing a mirror image with reference to the defined viewing direction.

20. A convertible with a rearview mirror, the rearview mirror comprising:
a display layer for displaying information by emission of light; and
a reflective-type polarization layer disposed in front of said display layer with reference to a defined viewing direction.
